(19) United States
(12) Patent Application Publication
(10) Pub. No.: US 2009/0053517 A1
(43) Pub. Date: Feb. 26, 2009

(54) Antifreeze tape and method of making the same

(76) Inventor: Zhuliang Su, Jiaolian (CN)

Correspondence Address: KIRSCHSTEIN, OTTINGER, ISRAEL;& SCHIFFMILLER, P.C., 425 FIFTH AVENUE, 5TH FLOOR, NEW YORK, NY, 10016-2223, US

(21) Appl. No.: 11/894,167

(22) Filed: Aug. 20, 2007

(51) Int. Cl. B32B 7/12; B05D 5/10

(52) U.S. Cl. 428/343; 427/208.4

(57) ABSTRACT

A cold temperature-resistant tape includes a carrier plastic film having opposite major surfaces, and a mixture coated on one of the major surfaces. The mixture includes a pressure-sensitive adhesive and an antifreeze having ethylene glycol for lowering a freezing point of the mixture. The tape maintains its functionality over long-term cold exposure without curling, cracking, or self-peeling.

### BACKGROUND OF THE INVENTION

Pressure-sensitive adhesive plastic tape of various compositions were and are employed in a myriad of applications, for example, the shipping industry in which cartons are taped closed before being transported. The most common mode of tape sealing rectangular shipping cartons involves applying tape runs along the top and bottoms thereof to overlap and thereby secure infolded flap members with the tape runs, the tape runs having anchoring run segments which are adhered on the opposite carton end walls between which the carton top and bottom wall defining infolded flaps extend. With the advent of pressure-sensitive adhesive sealing tape and more efficient tape sealing machines, there has been achieved a high degree of reliability in effective and secure sealing of these cartons for protection of the contained contents.

However, this practice does not reliably environmentally seal the carton, i.e., isolate the carton interior and contents from ambient cold weather conditions such as encountered in a refrigerated warehouse or truck in which the cartons are stored for short- or long-term storage. Nor does the tape stay reliably in place when exposed to a cold environment. Pressure-sensitive adhesives typically reduce or lose their tack at cold temperatures. Over time, the tape cracks, curls up and self-peels away from the carton, aided by the freezing of moisture that tends to creep in under the tape. As a result, the functionality of the tape is degraded.

In another common cold weather application, food wrapping materials such as paper, plastic wrap, and aluminum foil are taped closed by so-called “freezer tape”, which adheres to the food wrapping materials for a tight, moisture-resistant seal. The pressure-sensitive adhesive is formulated to resist cold temperatures. The tape-wrapped food is frequently stored in a household or commercial refrigerator or freezer to preserve the otherwise perishable food.

However, experience has shown that the commercially available freezer tape does not reliably survive extreme cold storage temperatures. Frequently, moisture creeps under an adhesive layer of the freezer tape and freezes in place. As a result, the freezer tape cracks, curls up and loses its functionality over long-term cold exposure. The food is subject to “freezer burn” and may become unacceptable to eat.

### SUMMARY OF THE INVENTION

One object of the present invention is to provide a pressure-sensitive adhesive plastic tape, which is resistant to cold temperatures, especially of the kind encountered in a refrigerated warehouse or truck, or household or commercial refrigerator or freezer, but also including temperatures down to around −40 degrees Centigrade. As used herein, the term “plastic tape” means a flexible strip of plastic carrier film having an essentially constant width and initially a length that is a large positive multiple of its width.

More specifically, a tape of this kind is provided with opposite major surfaces. A mixture is coated on one of the major surfaces, and sometimes both of the major surfaces. The mixture includes a pressure-sensitive adhesive and an antifreeze.

Preferably, the antifreeze includes ethylene glycol, especially monoethylene glycol and diethylene glycol. The mixture advantageously includes 99 percent by volume of the pressure-sensitive adhesive and 1 percent by volume of the antifreeze. The tape is wound convolutely upon itself about a core to form a supply roll.

In accordance with this invention, the antifreeze is operative for lowering a freezing point of the mixture. Any moisture that creeps under the tape will not freeze and cause the tape to curl up, crack, and lose its functionality over long-term cold exposure. The tape will stay reliably in place when exposed to a cold environment. Any item, such as perishable food in a taped wrapper, or the contents of a taped carton, will be more reliably preserved and protected from cold damage.

The cold temperature-resistant tape may be provided inexpensively by diverse means, as described hereinbelow by way of example.

In another aspect of the invention, a simple and inexpensive method of producing a cold temperature-resistant tape may be performed by mixing a pressure-sensitive adhesive and an antifreeze to form a mixture having a lowered freezing point for the mixture; and coating the mixture on a major surface of a carrier film, or on both of the major surfaces thereof.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a depiction of a method of making a cold temperature-resistant tape in accordance with this invention; and

FIG. 2 is a perspective view of a freezer in which a shipping carton is taped closed with the cold temperature-resistant tape made in accordance with the method of FIG. 1.

### DETAILED DESCRIPTION OF THE PREFERRED EMBODIMENTS

One feature of the invention comprises the rendering of a pressure-sensitive adhesive plastic tape resistant to cold temperatures, especially of the kind encountered in a refrigerated warehouse or truck, or household or commercial refrigerator or freezer, but also including temperatures down to around −40 degrees Centigrade.

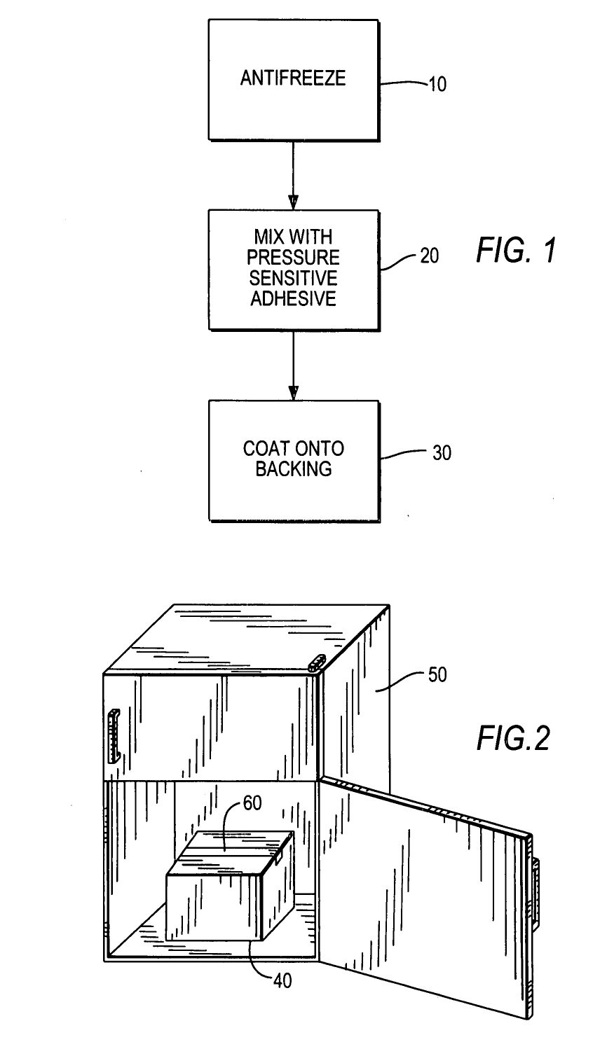

As shown in FIG. 1, an exemplary method of rendering the tape resistant to such cold temperatures is performed by mixing an antifreeze (step 10) with a pressure-sensitive adhesive (step 20) to form a liquid mixture, and coating the liquid mixture (step 30) on a major surface of a carrier film, or on both of the major surfaces thereof, of a plastic tape, i.e., a flexible strip of plastic carrier film having an essentially constant width and initially a length that is a large positive multiple of its width. The coating is dried in a hot air drier or allowed to air-dry, and, after drying, the tape is advantageously spirally wound convolutely upon itself about a core to form a supply roll.

In use, a desired length of the pressure-sensitive adhesive plastic tape 60, as shown in FIG. 2, is withdrawn and severed from a supply roll, and then applied to a carton 40. Reference numeral 50 represents a cold temperature environment, such as a household or commercial refrigerator or freezer, in which the carton is stored.

Preferably, the antifreeze includes ethylene glycol, especially monoethylene glycol and diethylene glycol. The mixture advantageously includes 99 percent by volume of the pressure-sensitive adhesive and 1 percent by volume of the antifreeze.

In accordance with this invention, the antifreeze is operative for lowering a freezing point of the mixture. Hence, the mixture will not freeze, and any moisture that creeps under the tape 60 and contacts the adhesive will not freeze and cause the tape to curl up, crack, and lose its functionality over long-term cold exposure. The tape 60 will stay reliably in place on the carton 40 when exposed to the cold environment of the freezer 50. Any item, such as perishable food in a taped wrapper, or the contents of the taped carton 40, will be more reliably preserved and protected from cold damage.

Advantageously, the formulation of the mixture consists essentially of 99.9 percent by volume of monoethylene glycol and 0.01 percent by volume of diethylene glycol in water, and trace amounts by volume of iron and an organic dyestuff to impart color thereto. Approximately, 0.000001 liter of the mixture is mixed with one liter of the adhesive.

The pressure-sensitive adhesive layer is usually composed of a synthetic or natural rubber (more recently of an acrylic polymer) and may contain a variety of softeners, antioxidants, plasticizers, and curing agents. The backing or carrier film may be a foil, crepe paper, fabric, cellophane, cellulose acetate, plasticized polyvinyl chloride, or any of a number of other flexible materials and may be reinforced with glass or other fibers.

It will be understood that each of the elements described above, or two or more together, also may find a useful application in other types of constructions differing from the types described above.

While the invention has been illustrated and described as embodied in a cold temperature-resistant tape and method of making the same, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention and, therefore, such adaptations should and are intended to be comprehended within the meaning and range of equivalence of the following claims.

What is claimed as new and desired to be protected by Letters Patent is set forth in the appended claims.

I claim:

1. A cold temperature-resistant tape, comprising:
a carrier film having opposite major surfaces; and
a mixture coated on one of the major surfaces, the mixture including a pressure-sensitive adhesive and an antifreeze for lowering a freezing point of the mixture.

2. The tape of claim 1, wherein the film is a plastic material.

3. The tape of claim 1, wherein the antifreeze includes ethylene glycol.

4. The tape of claim 1, wherein the antifreeze includes monoethylene glycol and diethylene glycol.

5. The tape of claim 1, wherein the mixture includes 99 percent by volume of the pressure-sensitive adhesive and 1 percent by volume of the antifreeze.

6. A cold temperature-resistant tape, comprising:
a carrier plastic film having opposite major surfaces; and
a mixture coated on one of the major surfaces, the mixture including a pressure-sensitive adhesive and an antifreeze having ethylene glycol for lowering a freezing point of the mixture.

7. A method of making a cold temperature-resistant tape, comprising the steps of:
mixing a pressure-sensitive adhesive and an antifreeze to form a mixture having a lowered freezing point for the mixture; and
coating the mixture on a major surface of a carrier film.

8. The method of claim 7, and constituting the film of a plastic material.

9. The method of claim 7, and constituting the antifreeze with ethylene glycol.

10. The method of claim 7, and constituting the antifreeze with monoethylene glycol and diethylene glycol.

11. The method of claim 7, and constituting the mixture with 99 percent by volume of the pressure-sensitive adhesive and 1 percent by volume of the antifreeze.
